(19) United States
(12) Patent Application Publication
(10) Pub. No.: US 2017/0112180 A1
(43) Pub. Date: Apr. 27, 2017

(54) METHOD AND APPARATUS FOR THE APPLICATION OF OIL TO NON-FRIED SNACK FOOD PRODUCTS

(71) Applicant: JIMMYASH LLC, Santa Monica, CA (US)

(72) Inventors: Jamshid ASHOURIAN, Santa Monica, CA (US); David PHELPS, Beaverton, OR (US); Christopher IMDIEKE, Woodburn, OR (US)

(21) Appl. No.: 15/400,016

(22) Filed: Jan. 6, 2017

Related U.S. Application Data
(63) Continuation-in-part of application No. 15/295,394, filed on Oct. 17, 2016.
Application No. 15/295,394 is a continuation-in-part of application No. PCT/US2016/057342, filed on Oct. 17, 2016.
(60) Provisional application No. 62/275,464, filed on Jan. 6, 2016.
(60) Provisional application No. 62/241,973, filed on Oct. 15, 2015.
(60) Provisional application No. 62/265,473, filed on Dec. 10, 2015.

(51) Int. Cl. A23P 20/15; A23P 20/10

(52) U.S. Cl. CPC A23P 20/15; A23P 20/11

(57) ABSTRACT

The present invention relates to a mechanical emulsification tank and processing unit. In particular, the invention relates to an continuous feed conveyor fed emulsifier used to immerse and process food products, and in particular snack foods, as part of a process for preparing such items for further steps such as cooking, baking, or frying.

### RELATED APPLICATIONS

The present application claims priority to and incorporates by reference the following applications: U.S. Utility application Ser. No. 15/295,394 filed on Oct. 17, 2016; PCT Application No. PCT/US2016/057342 filed on Oct. 17, 2016, U.S. Provisional Patent Application No. 62/275,464 filed on Jan. 6, 2016, U.S. Provisional Patent Application No. 62/265,473 filed Dec. 10, 2015, and U.S. Provisional Patent Application No. 62/241,973 filed Oct. 15, 2015.

### BACKGROUND OF THE INVENTION

Field of the Invention

The present invention relates to a mechanical emulsification tank and processing unit. In particular, the invention relates to a continuous feed emulsifier used to immerse and process food products, and in particular snack foods, as part of a process for preparing such items for further steps such as cooking, baking, or frying,

Background

A review of the patent literature reveals numerous attempts to lower the fat content of fried food products, and in particular potato chips, as well as equipment used to carry out the foregoing.

These include conditioning the surface of the food product prior to a frying and/or cooking step. Another category of methods of reducing fat content is to prepare the food pieces with full fat content through traditional frying methods and to subsequently remove some of the oil through, e.g., centrifugal force, superheated steam, or other methods. Other methods of food preparation, which seek to reduce the final oil content, involve alternative methods of drying without frying in oil, such as microwave heating, convection ovens, dryers, etc, These methods suffer from a number of drawbacks, including the difficulty in achieving a uniform coating of oil, adding a great deal of complexity and therefor cost to the process, controlling variation due to temperature which affects viscosity and oil uptake, and other problems.

All methods mentioned above have not accounted for the potential of using emulsive mixtures consisting of oil and water in a predetermined ratio as part of a preparation step prior to drying via a cooking method that does not introduce any oil to the product. This process permits the production of snack foods with a wide range of fat contents; anywhere from trace amounts to amounts approaching those of traditionally fried foods. Furthermore, the prior art does not teach an apparatus suited for the foregoing.

In particular, with emulsifiers that mix oil and water for example, the prior teaches the use of stabilizers to ensure that the emulsion can be sustained during operation, which is a limitation that prior equipment has not been able to address. These stabilizers include emulsifiers or surfactants, which can have a negative effect on the products processed by the apparatus, especially food products by affecting the taste of the product and/or introducing chemicals to the process that are not necessary and might prove harmful. Still further, prior art emulsion equipment is batch processing devices that lack the ability to adapt to high volume continuous operation, which greatly limits overall production. and throughput.

Thus, a need exists for an emulsifier that substantially, or completely, eliminates the problems of the prior art.

### BRIEF DESCRIPTION OF THE FIGURES

FIGS. 1A, B, and C show a top, side, and end views of the emulsifier respectively.

FIGS. 2A and B show a top and side view of the emulsifier respectively, and FIGS. 2C, D, E, F, and G show a top and side views of the emulsifier piping.

FIGS. 3A and B show a side and top views of the emulsifier with detailed close up views corresponding thereto, which are shown in greater detail in the following figures.

FIG. 4 is a side view of the emulsifier,

FIG. 5 is a side top view of the emulsifier with the hood open.

FIG. 6 is a side back view of the emulsifier.

FIG. 7 is an end view of the emulsifier and of the conveyer.

FIG. 8 is a top view of the emulsifier.

FIG. 9 is a top end view of the emulsifier with the hood closed.

FIG. 10 is an end view of the conveyer of the emulsifier.

FIG. 11 is a view of the heating system.

### DETAILED DESCRIPTION OF THE INVENTION

The present invention relates to an apparatus for the preparation of foods, in particular snack foods, with a precisely controllable fat content in which the food pieces are immersed in a water and oil emulsion prior to heating and drying or cooking steps. The emulsification step, and the equipment for carrying out that step is crucial to the success of the process, and the foregoing is not taught by the prior art.

More particularly the invention relates to a continuous feed apparatus for the application of the emulsion to most preferable snack food products (but not necessarily limited thereto), where such products have traditionally been fried in oil, and are dried through other means, in order to produce a final product possessing similar organoleptic properties to the fried foods but with a substantially reduced fat. The invention is, however, not so limited. The invention can be used with any product that can be prepared using oil, or an oil coating, such as snack foods, like potato chips, crisps, skins, wedges, fries, rinds, flour or cake products, pretzels, crackers, breads, doughs, corn based chips, fritters, tortillas, tofu, vegetables, fruits, candies, cheese, meats, poultry, beef, seafood, shellfish, and the like, including any product that is fried, baked, microwaved, dehydrated, or cooked in any other manner.

Traditional means of preparation of fried foods often involves frying the product in oil. This cooks the food pieces and at the same time removes their native moisture to a desired degree (with minimal loss of nutrient content); in the case of potato chips, for example, typically resulting in final cooked product that is typically about 2-3% moisture by weight. However, the frying process also results in a significant degree of oil retention in the final product: Traditional fried potato chips, for example, contain oil up to 30%-40% by weight or higher in some cases.

There is an increasing demand for low-fat food including snack food products owing to concerns about adverse long-term health consequences attending consumption of high-fat foods. In addition, the frying process produces potentially deleterious by-products such as acrylamides. Thus, there is an increasing demand for healthier fried food including snack food alternatives that are lower in fat and for food and snack foods that are processed by means other than frying.

The present invention; therefore, relates to an apparatus for applying a water and oil emulsion to provide precise control to the delivery of oil to food pieces prior to cooking or drying via an oil-free cooking method. The cooking or drying step can utilize any method that includes, but not limited to convection ovens, microwave heating, fluidized bed dryers (of the type disclosed in U.S. Provisional Patent Application No. 62/241,973 filed on Oct. 15, 2015 and U.S. Provisional Patent Application No. 62/265,473 filed on Dec. 10, 2015), vibrating fluidized bed dryers, vacuum dryers or ovens, impingement ovens or dryers, belt dryers or ovens, ohmic dryers or ovens, spray drying, pneumatic dryers or ovens, freeze dryers or ovens, drum dryers, infrared dryers or ovens, centrifugal dryers or ovens, belt presses, osmatic dehydration devices, ultrasonic and acoustic enhanced or assisted dehydration devices, refractance window, zeodration, or any other method of cooking or drying etc. In an alternative embodiment food and snack food products coated with the oil water emulsion can be cooked in a fryer employing any deep frying methods or devices. This method and apparatus for oil application provides for an even coating of oil on the surface of the food pieces, as opposed to apparatus that spray oil onto product Which provides uneven coverage. Furthermore the process carried out on the apparatus described herein offers an advantage over oil immersion methods in that it allows for precise control over the oil content of the finished product beyond the typical fried product range to be achieved.

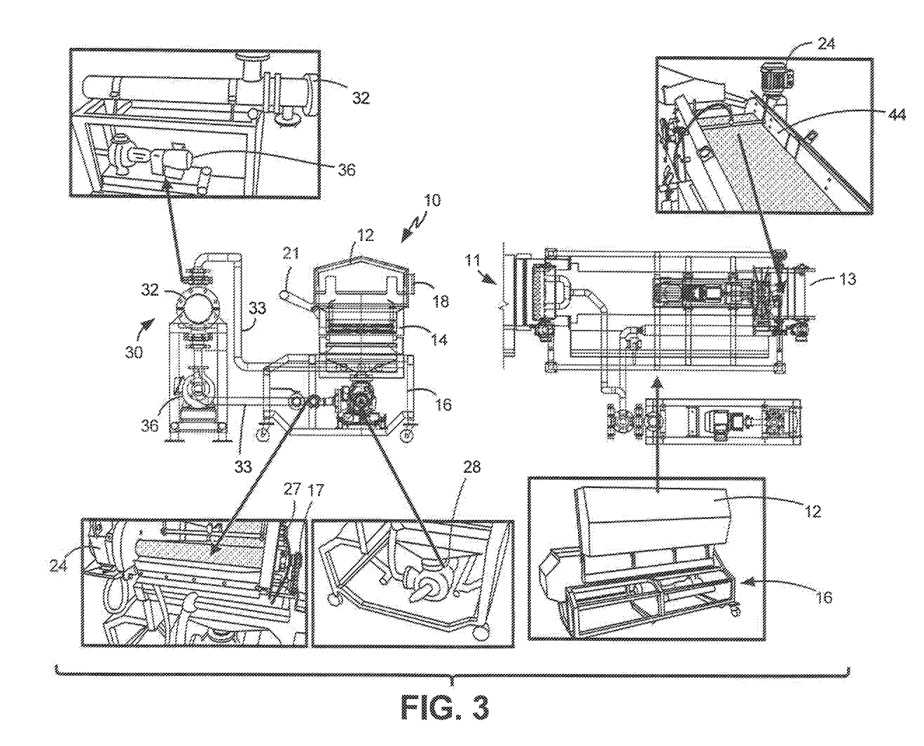

In the Figures, is shown an oil dip fryer/emulsifier apparatus 10 used to carry out the above-described method. The apparatus 10 comprises generally a hood 12, a tank 14, and a wheeled frame 16. Further the apparatus 10 includes an input end 11 and an output end 13. Material processed by the apparatus is feed into a gap between the hood 12 and the tank 14 at the input end 11. The material moves to the output end 13 on a conveyor 15. Driven by a drive motor 24 that turns an axle 27 connected to gears 17 (see FIG. 3 for example) located on the side of the apparatus opposite to the drive motor 24. Thereby, moving the conveyor 15 in a circular path such that material moves from the input end 11 to the output end 13.

The tank 14 contains a continuously circulating emulsion solution of preferably oil and water, but not necessarily limited there to. The circulation is under a circulation system. The circulation system includes a shear pump 28 located under the tank 14 on a platform connected to the wheeled frame 16. The circulation system also includes a heat exchanger 30 connected to the pump 28 and the tank 14.

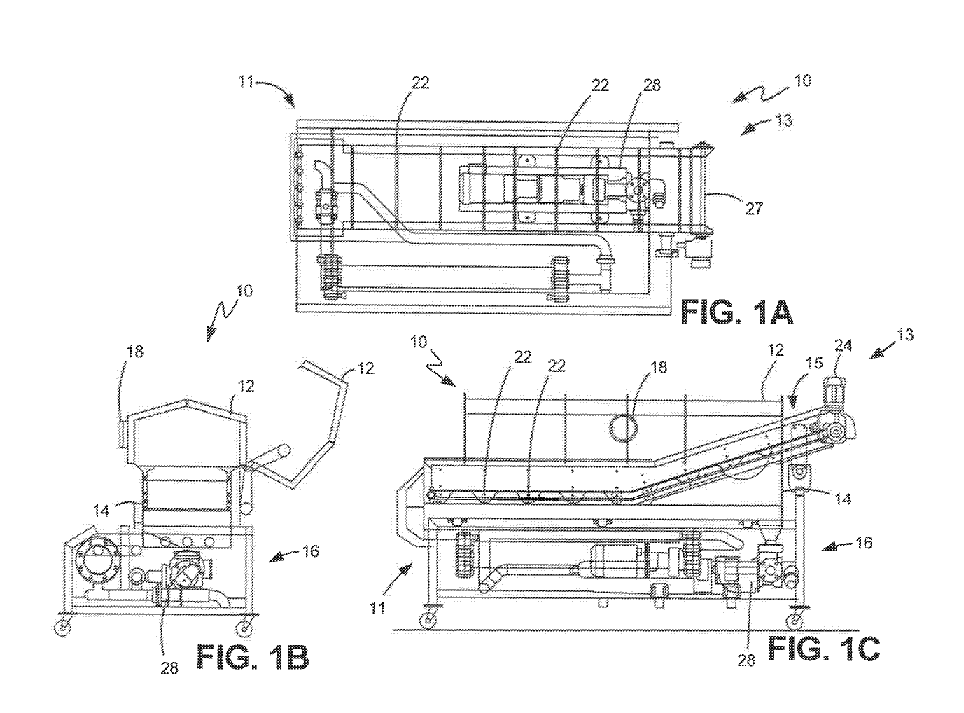

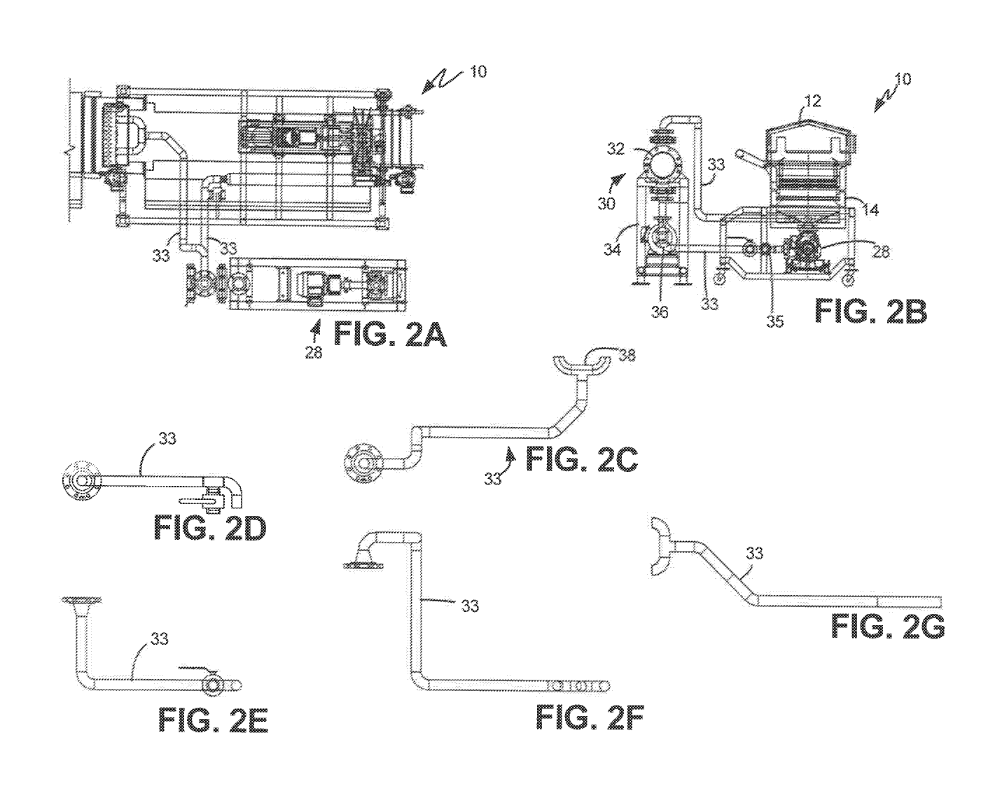

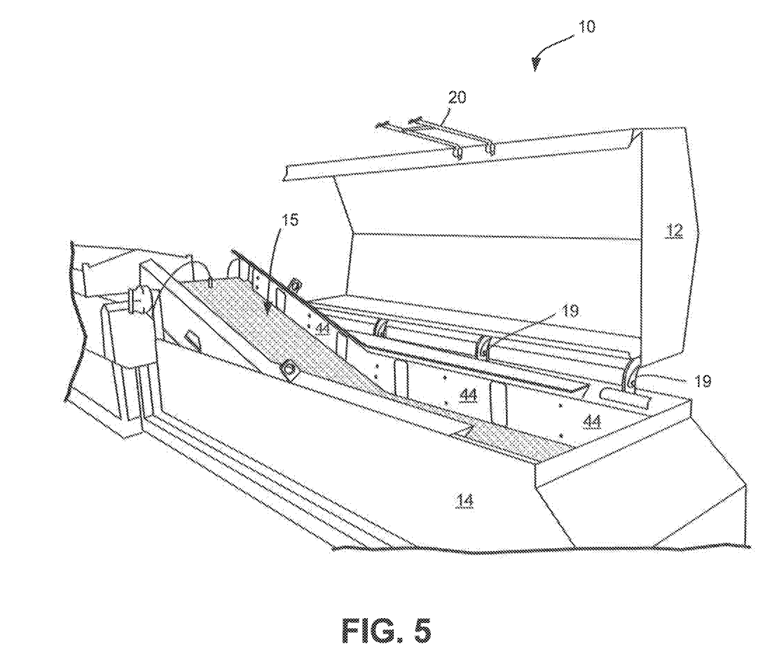

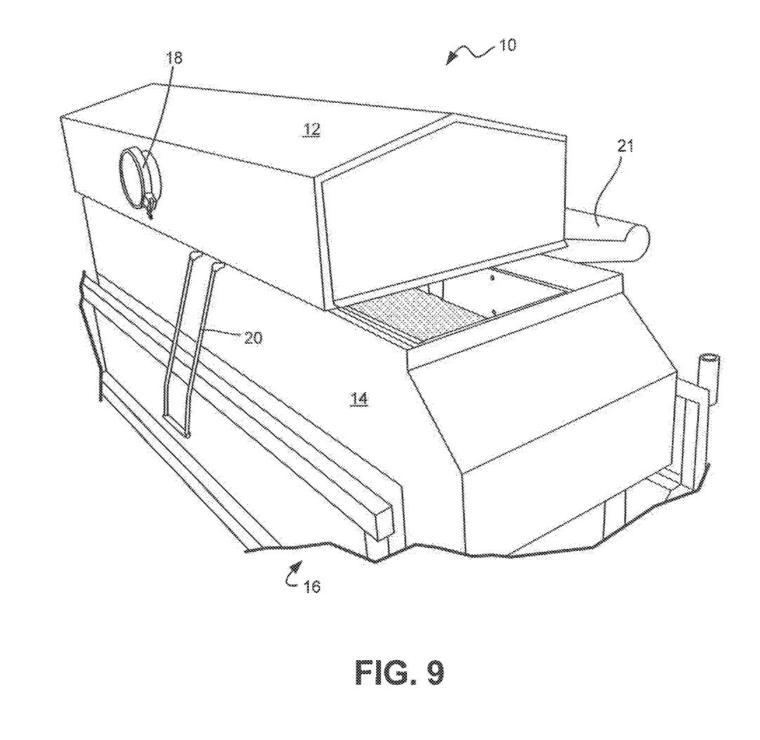

In particular reference to the FIGS. 1 and 2, which show various views of the apparatus 10, that includes the general orientation of the hood 12, tank 14, and frame 16. The hood 12 includes a handle 20 (FIG. 9), which allows for moving the hood 12 between an open and closed position (the hood can be raised and lowered by other means as well such as screw jacks, hydraulic or piston cylinders, or other mechanical means). The hood 12 connects to the tank 14 with a plurality of pivoting joints 19 (FIG. 5). Additionally, the hood 12 and tank 14 may be insulated to reduce the amount of heat the emulsion solution loses during operation (or otherwise).

The tank 14 also includes a plurality of internal conveyor supports rods 22 (FIG. 1). The conveyor 15 is structurally held in pace between the sides of the tank 14 by the rods 22. The conveyor belt travels above the rods 22 as it carries product, and the return path of the conveyor best is below the rods 22.

FIGS. 1-3 show the components of the circulation system, which includes the heat exchanger 30 and the oil dip/fryer pump 28. The heat exchanger 30 includes a shell and tube heat exchanger unit 32 that is placed on top of a stand 34 (other configurations/designs of the heat exchanger can be used as well such as a plate and frame, or tube and tube are other examples). Underneath the heat exchanger unit 32 is a thermal oil exchange pump 36. Piping 33 connects the shell and tube heat exchanger unit 32 to the shear pump 28 located under the tank 14, and thereby connecting the heat exchanger unit 32 to the tank 14.

The emulsion solution cycles continuously through. the circulation system as follows: the solution flows from the tank 14 to the shear pump 28, then through piping 33a (supply) to the thermal oil exchange pump 36, then to the heat exchanger 32, and then through piping 33b (return) back to the tank 14 (this section of the piping has a Y-shaped connection 38 to the tank 14).

The shell and tube heat exchanger 32 is heated by thermal fluid that is piped through the shell and tube heat exchanger 32, via the thermal heat pump 36, from a thermal fluid heating system (described in the patent applications attached hereto in the Appendix—reference numeral 112 in FIG. 52). Heat is transferred from the thermal fluid to the emulsion as the thermal fluid flows through the heat exchanger 32. While heating or cooling the emulsion solution of the present invention by a central or external device such as a circulating oil thermal fluid system, as described herein, is among the novel features of the present invention, alternatively, another heating or cooling source can be used to regulate the desire temperature of the emulsion solution (i.e., water-oil or any other fluid and/or oil combination). Examples of such heating or cooling sources include electrical coils, shell and tube heat exchangers heated by boiler systems, cooled by any freezing and/or cooling device or systems, and/or gas burners or other cooling systems and the like.

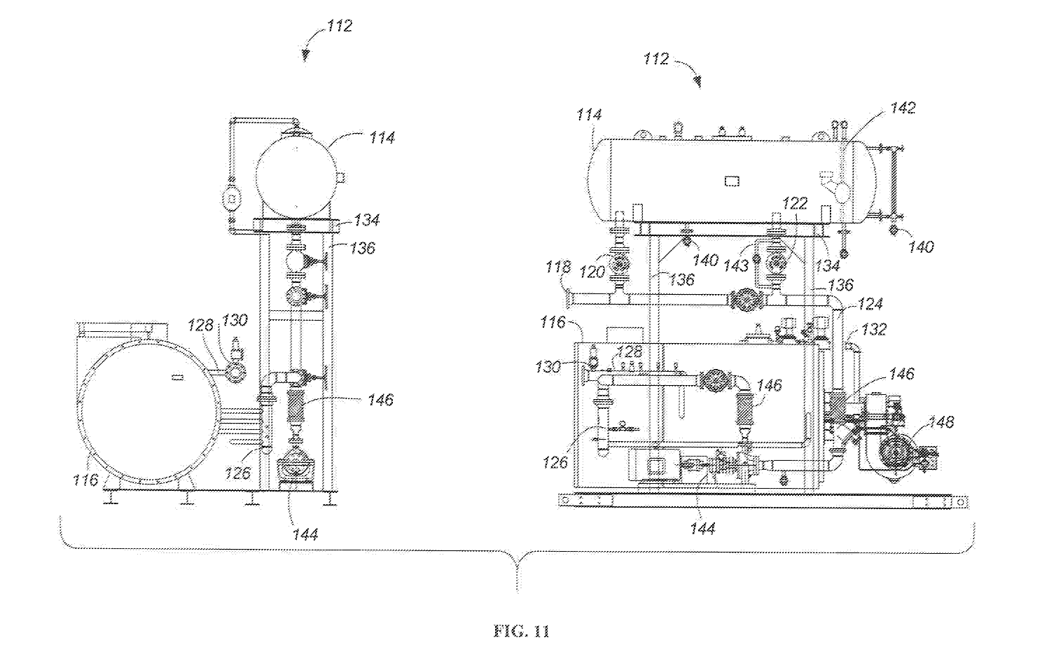

FIG. 11 shows the thermal fluid heating system 112 of the present invention. The system 112 provides for an indirect method of heating the air used in the dryer 10, by heating a thermal fluid that is then conveyed through pipes to the heating coils 50 contained in the heating units 48. In this manner, any particulates, contaminants, pollutants associated with the heating step are remote from the apparatus 10 and the air stream used therein. Thus, such elements cannot contaminate any product processed in the apparatus 10, which is especially important when the product is food. Other advantages of the use or remote heat is that the heating elements, can be separately housed making it easier to filter out pollutants, particles, or harmful gasses resulting from the use thereof.

In particular, the system 112 comprises a thermal fluid reservoir 114 that stores the thermal fluid used by the system 112, and a burner 116 where the fluid is heated. The reservoir 114 sits on a platform 134 which is held in place by supports 136. Elevating the reservoir 114 and maintaining fluid therein assists in maintaining pressure in the system 112, however, a fan cooled thermal fluid pump 144 is also provided and is the principle source of pressure in the system 112.

The reservoir 114, in the preferred embodiment of the invention, comprises a pressurized tank. External pressure tanks (not shown), preferably containing nitrogen, are used to blanket the thermal fluid with an inert gas and thus prevent condensation and oxidation (also prevents moisture from entering the tank). The external tanks connect to valves at the top of the reservoir 114. Relief valves are provided on the pressurized tank lines as well.

The fluid circulates to the heating coils 50 though a fluid system return line 118, and a fluid system input line 130. Additionally, a pump 113 assists with moving the thermal fluid between the heating coils 50 and the system 112. The return line 118 receives fluid from the coils 50 via piping, and fluid is sent to the coils 50 through the input line 130. Fluid travels to and from the reservoir 114 and into a burner input line 124 through reservoir input line 120 and a reservoir output line 122, both lines include valves located below the reservoir 114 that can be opened and closed as needed.

The burner 116 is preferably powered by natural gas which is fed into the system through natural gas inlet 132 (alternatively, fuel oil, LPG or other sources power can he used; further air can be fed into the burner 116 to enhance combustion). The burner 116 includes (internally) a series of gas fired combustion coils that ignite and transfer heat to a series of fluid coils through which the thermal fluid is moved allowing heated air to transfer heat to the thermal fluid. A forced air blower 148 provides combustion air to the burner 116. The burner 116 includes an exhaust stack 138, through which hot air and combustion gases are vented. Because the system 112, including the burner 116, is remotely located from the apparatus 10 the byproducts of the exhaust cannot contaminate any product being processed in the apparatus 10. This also helps provide access for filtering and removal of harmful elements from the exhaust stream, again without interference with the apparatus 10.

Additionally, the reservoir includes a drain 140, a fluid level control mechanism 142 (located partially in the tank), a fire protection valve 143, and expansion joints 146 are located at various points to allow for expansion and contraction of the connecting pipes and tubing that result during operation.

Using the thermal heating system provides for an indirect method of heating the emulsion used in the apparatus 10, by heating a thermal fluid that is then conveyed to the heat exchanger 32. In this manner, any particulates, contaminants, pollutants associated with the heating step are remote from the apparatus 10 and the emulsion used therein, which is in contact with the product processed by the apparatus. Thus, such elements cannot contaminate any product processed in the apparatus 10, which is especially important when the product is food. Other advantages of the use or remote heat is that the heating elements, can be separately housed making it easier to filter out pollutants, particles, or harmful gasses resulting from the use thereof.

A filter 35 is provided between the shear pump 28 and the heat exchanger 32. The filter 35 can be constructed from any suitable material used in the food industry, including paper and is adapted to filter out particulate as small as 0.2 micron which allows for use of the invention in numerous applications including producing medicinal products because bacteria can be filtered out. In particular, the filter 35 is a commercially available filter, an Eaton DCF-1600 filter, which is adapted for filtering viscous, abrasive, or sticky liquids. The filter includes a stainless steel tank with a paper cartridge filter inside to remove debris. Liquid flows into the interior of the filter, and is forced through the walls of the filter to the exterior of the tank and then out of the tank. Debris is trapped inside the filter. The filter includes a cleaning disk which rides up and down inside the filter through operation of dual actuator pistons. The pistons and disk move the fluid out of the filter and the debris inside the filter is moved to the bottom of the filter on the down stroke. The debris is then removed with an air-activated purge valve. Depending on the intended use of the present invention, the filter 35 may be replaced with other filters including any filters used in the food, drug, or industrial applications. Alternatively multiple filters each dedicated to a particular purpose may be installed.

The heat exchanger 30 can he used to heat or cool the emulsion to any desired temperature. The temperature range can he from just above the freezing point of the emulsion to just below boiling. The temperatures can vary depending on the nature of the emulsion, which can be a mixture of oil and water or of two different oils, and the like. The temperature can range from 32° Fahrenheit to 212° Fahrenheit, or higher up to 400° Fahrenheit. A drain 37 is located on the piping 33a between the shear pump 28 and the thermal oil pump 36, at the low point of the system. In addition to circulating the emulsion to the heat exchanger, the thermal oil pump 36 circulates the thermal fluid from the thermal heating system described in the Appendix to the heat exchanger 32 to heat the emulsion product to the desired temperature.

The shear pump 28 is a commercially available DynaShear Model DS-575 (of course, other similar designed pumps from various manufacturers can be used without departing from the scope of the present invention). In general, shear pumps are used to create emulsions whereby the pump/mixer disperses, or transports, one phase or ingredient (liquid, solid, gas) into a main continuous phase (liquid), with which it would normally not form a stable homogenous mixture. A rotor or impeller, together with a stationary component known as a stator, or an array of rotors and stators, is used either in a tank containing the solution to be mixed, or in a pipe through which the solution passes, to create shear. Fluid undergoes shear when one area of fluid travels with a different velocity relative to an adjacent area. A high-shear mixer uses a rotating impeller or high-speed rotor, or a series of such impellers or inline rotors, usually powered by an electric motor, to “work” the fluid, creating flow and shear. The tip velocity, or speed of the fluid at the outside diameter of the rotor, will be higher than the velocity at the center of the rotor, and it is this velocity difference that creates shear.

Because the solution is continuously moved through the circulation system, including the shear pump 28, it is possible to maintain stability with otherwise unstable emulsions, and thus the need to use surfactants or other stabilizers to maintain the emulsion is eliminated.

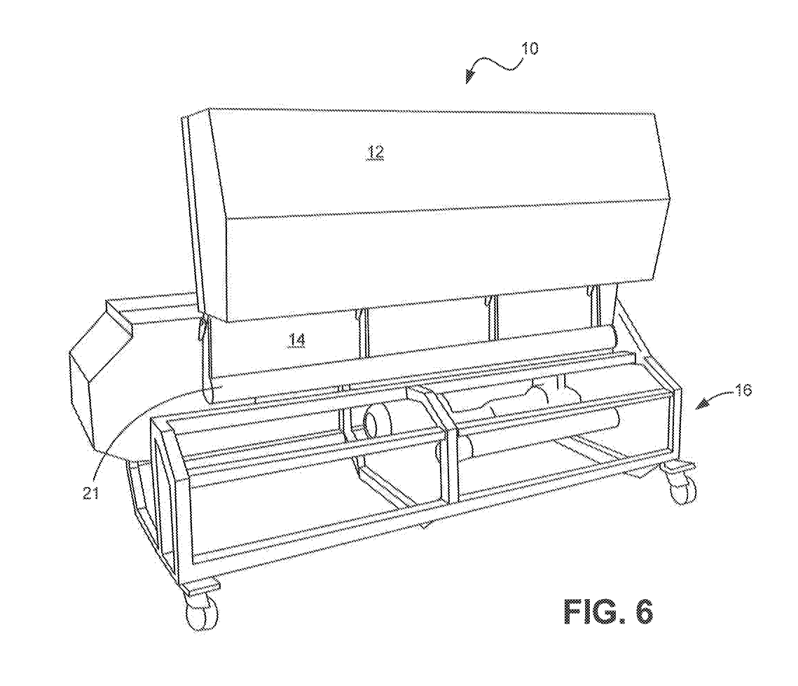

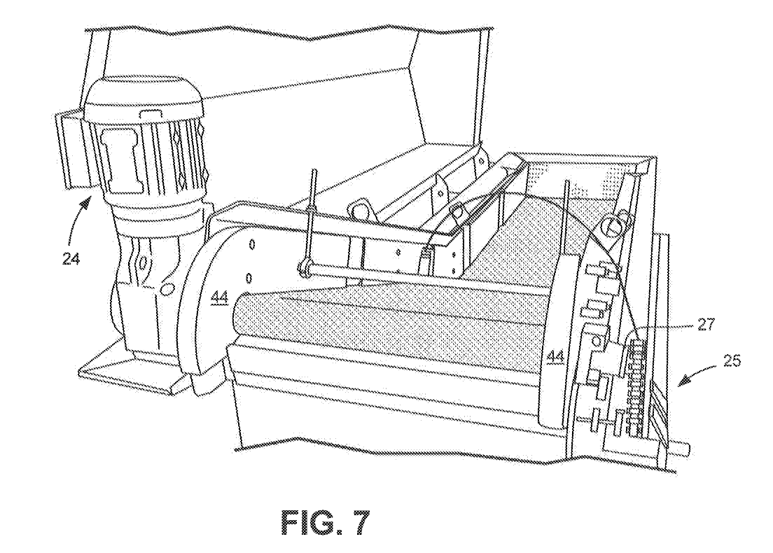

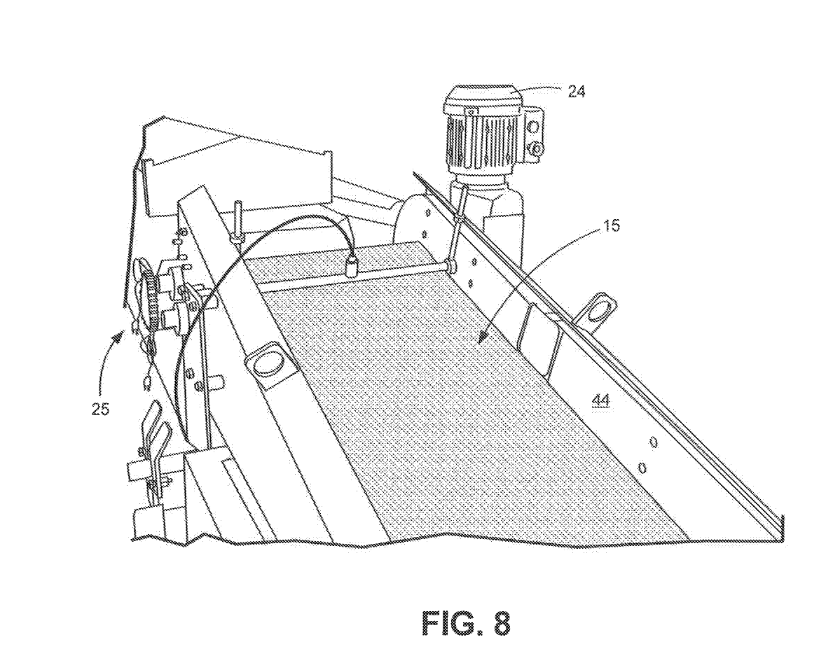

FIG. 3 shows a correlation between various elements of the apparatus and other following Figures, which show the indicated elements of the apparatus in greater detail. In particular, the heat exchanger 32 and thermal pump 36 are located, the discharge end of the conveyor 15 is located (see FIGS. 7, 8), the input/infeed end of the conveyor 15 is located (see FIG. 11), the shear pump 28 is located (see FIG. 1), and the hood 12 is located (see FIG. 6).

The present invention can comprise a component of a greater food preparation process (however, use of the invention is not limited to the foregoing). In this case, generally, the process starts with feeding whole raw potatoes into a processing device, which can comprise a sweet potato cutter, a mini-fries cutter, or other type of cutter/slicer (such as a commercially available Ursehel CC Cutter). The cut material is then washed on a belt conveyor washer. The material is then feed to an enzyme treatment tank to coat the product with an enzyme helpful for effective processing of the material. The material then moves to a blancher, which partially cooks the material. Then the material moves to the apparatus 10 of the present invention. The material can then be moved to a dryer (of the type disclosed in Provisional Patent Application No. 62/241,973).

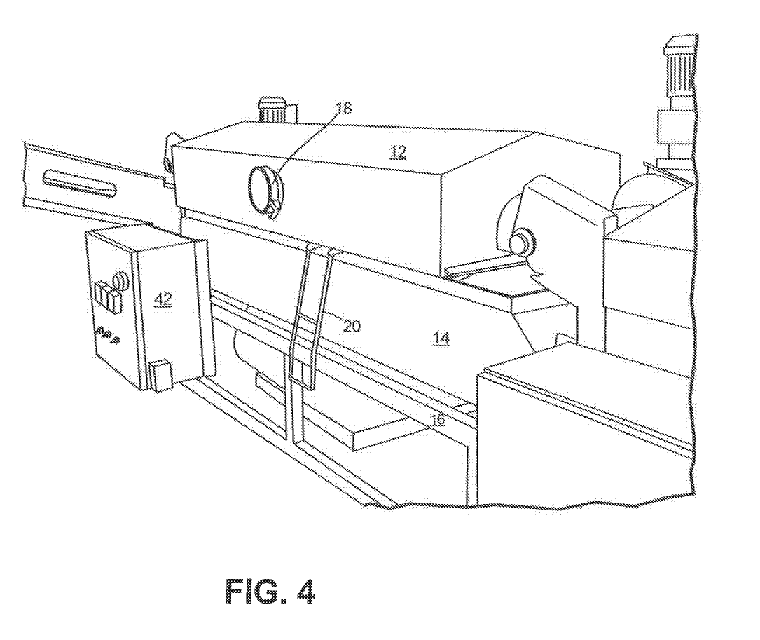

FIG. 4 shows a side perspective view of the apparatus 10. In this view the apparatus 10 is being feed from the blancher. A control panel 42 is provided, which includes controls for the various components of the apparatus 10. A vent 18 is located in the hood 12, which can be opened or closed as necessary during operation of the apparatus.

FIG. 5 shows the apparatus with the hood 12 in the raised position (as noted earlier there are other methods/designs in which the hood can be raised). The conveyor 15 is shown, and in particular, it can be seen that the conveyor is sloped at the output end to allow for the material to be fed off of the conveyor and transferred to the next step in the process (if any).

FIG. 6 shows a view of the apparatus 10 with the hood 12 in the raised position on the backside. The hood includes a stop/counter weight 21, which prevents the hood from moving beyond the position shown in FIG. 7. The weight also makes it easier to raise the hood 12.

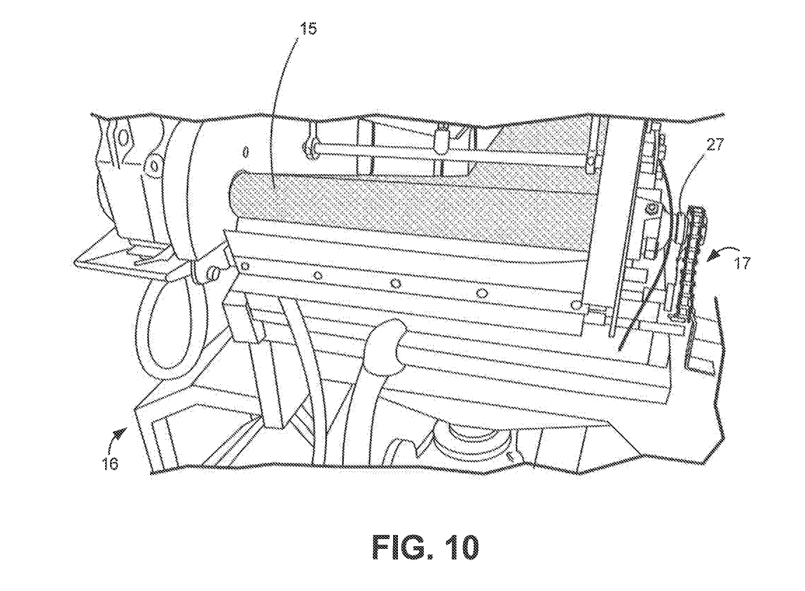

FIGS. 7 and 10 show the apparatus 10 from the output end. Sides of the conveyor 15 include Ultra High Molecular Weight (UHMW) polyethylene 44 guides that prevent the product from falling off the side of the wedgewire conveyor or hanging up on the edge, while providing a smooth surface for the processed material to move on. The drive motor 24 and drive gears 25 are shown. The drive motor 24 engages an axle 27 upon which the conveyor moves. FIG. 8 provides a similar view as shown in FIG. 7, however, from the reverse angle.

FIG. 7, as well as other Figures, show a spray apparatus located above the upward sloping end of the conveyor 15. Tubing connects to the center of the spray mount bar through which a fluid is introduced and the product can be sprayed upon exiting the apparatus. The spray can comprise the emulsion, or another liquid such as water.

FIG. 9 shows the apparatus 10 with the hood 12 in the dosed position. There is a gap between the hood 12 and the tank 14 for infeed of the material processed in the apparatus 10.

FIG. 10 is an end view of the apparatus 10 and in particular the conveyor 15.

The present invention can be made in a variety of sizes and with a variety of capacities ranging from very small laboratory units handling as little as a few grams of products per minute of operation to very large units employed in manufacturing and industrial applications with a capacity or throughput of hundreds of pounds of products or ingredients per minute. Further the present invention may be operated both in a continuous or a batch mode.

1. A continuous feed emulsifier, comprising:
a tank defining a bottom, sides, and ends for containing an emulsion;
a continuous conveyor located at least partially in the tank to move product from an input end of the emulsifier to an output end of the emulsifier, where the product is at least partially immersed in the emulsion;
a recirculating system for moving the emulsion through the tank and for mixing the emulsion.

2. The invention of claim 1 where the recirculating system comprises a shear pump for maintaining the emulsion mix.

3. The invention of claim 1 further comprising a heating system for heating the emulsion.

4. The invention of claim 3 where the heating system comprises a thermal oil exchange pump for receiving thermal fluid.

5. The invention of claim 3 where the heating system comprises a heat exchanger for transferring heat to the emulsion.

6. The invention of claim 1 where the recirculating system comprises a shear pump for maintaining the mix of the emulsion, a thermal oil exchange pump for receiving a thermal fluid, a heat exchanger for transferring heat from the thermal fluid to the emulsion.

7. The invention of claim 6 where the thermal fluid can also be used to cool the emulsion.

8. The invention of claim 6 where indirect heating is used to heat the thermal fluid.

9. The invention of claim 6 where the recirculating system comprises a filter for filtering particulate matter from the emulsion.

10. The invention of claim 1 further comprising a hood for covering at least a portion of the tank.

11. The invention of claim 10 where the hood has a gap to allow product to be feed into the emulsifier when the hood is closed.

12. The invention of claim 1 where the conveyor is sloped at the output end to allow product to exit above the tank walls.

13. The invention of claim 1 further comprising a sprayer above the conveyor for spraying product.

14. The invention of claim 13 where the sprayer is at the output end of the conveyor.

15. The invention of claim 1 further comprising, guides to keep the product on the conveyor.

16. The invention of claim 15 where the guides are made of a smooth material to prevent product build up thereon.

17. The invention of claim 1 where the conveyor is driven by a drive motor and gears.

18. The invention of claim 10 where the hood has a vent.

19. The invention of claim 1 where the conveyor is comprised of a mesh material to allow the emulsion to flow through the conveyor.
